(19) United States
(12) Patent Application Publication
(10) Pub. No.: US 2022/0080458 A1
(43) Pub. Date: Mar. 17, 2022

(54) DATA PROCESSING ARCHITECTURE FOR ULTRASONIC CLEANING APPLICATION

(71) Applicant: TEXAS INSTRUMENTS INCORPORATED, Dallas, TX (US)

(72) Inventors: Supriyo PALIT, Kolkata (IN); James Kelly GRIFFIN, Garland, TX (US); David Patrick MAGEE, Allen, TX (US)

(21) Appl. No.: 17/475,886

(22) Filed: Sep. 15, 2021

Related U.S. Application Data
(60) Provisional application No. 63/079,013, filed on Sep. 16, 2020.

(51) Int. Cl. B06B 1/02; G02B 27/00; B08B 7/02; B08B 13/00

(52) U.S. Cl. CPC B06B 1/0215; G02B 27/0006; B06B 2201/55; B08B 13/00; B08B 7/028

(57) ABSTRACT

In an example, a method includes providing a pulse-width modulation (PWM) excitation signal to a piezo transducer via a transmit path. The method also includes collecting a block of samples of a current and a voltage at the piezo transducer, where the block of samples is collected in sub-blocks of samples between interrupts in a receive path. The method includes processing each sub-block of samples separately from other sub-blocks of samples. The method also includes, responsive to the sub-blocks of the block of samples being processed, analyzing the block of samples. The method includes, responsive to the analysis, modifying the PWM excitation signal.

### CROSS-REFERENCE TO RELATED APPLICATIONS

The present application claims priority to U.S. Provisional Patent Application No. 63/079,013, which was filed Sep. 16, 2020, is titled “Flexible Real-Time Data Processing Architecture To Improve Latency/Resolution And Optimize System Resources For Ultrasonic Cleaning Application,” and is hereby incorporated herein by reference in its entirety.

### BACKGROUND

Impedance measurement and analysis may be performed to provide a variety of functions. Impedance may be determined by measuring the current and voltage of a system. One example of a system that uses impedance measurement is an ultrasonic cleaning system. An ultrasonic cleaning system includes a piezo electric transducer that is excited using ultrasonic frequencies. The transducer, in turn, excites a surface (e.g., a lens to a camera, such as a camera on an automobile or a drone) that is to be cleaned. The surface vibrates, which shakes off debris and cleans the surface.

### SUMMARY

In accordance with at least one example of the description, a method includes providing a pulse-width modulation (PWM) excitation signal to a piezo transducer via a transmit path. The method also includes collecting a block of samples of a current and a voltage at the piezo transducer, where the block of samples is collected in sub-blocks of samples between interrupts in a receive path. The method includes processing each sub-block of samples separately from other sub-blocks of samples. The method also includes, responsive to the sub-blocks of the block of samples being processed, analyzing the block of samples. The method includes, responsive to the analysis, modifying the PWM excitation signal.

In accordance with at least one example of the description, a system for operating a piezo transducer includes a PWM signal generator adapted to be coupled to the piezo transducer and configured to generate a PWM signal. The system includes sensing circuitry adapted to be coupled to the piezo transducer and configured to sample current and sample voltage of the piezo transducer. The system includes a processor coupled to the PWM signal generator and the sensing circuitry. The processor is configured to provide transmit processing operations for the PWM signal. The processor is also configured to provide receive processing operations on the sample current and the sample voltage. The processor is also configured to initiate the transmit processing operations and the receive processing operations with a single processing thread.

In accordance with at least one example of the description, a method includes providing a PWM excitation signal with a first frequency to a piezo transducer. The method also includes collecting a first block of samples of a current and a voltage at the piezo transducer, where the first block of samples includes one or more sub-blocks. The method includes processing each of the one or more sub-blocks of the first block of samples separately from other sub-blocks of the first block of samples. The method also includes providing the PWM excitation signal with a second frequency to the piezo transducer. The method includes collecting a second block of samples of the current and the voltage at the piezo transducer, where the second block of samples includes one or more sub-blocks. The method also includes processing each of the one or more sub-blocks of the second block of samples separately from other sub-blocks of the second block of samples. The method includes, responsive to processing the first and second block of samples, adjusting a frequency of the PWM excitation signal.

### BRIEF DESCRIPTION OF THE DRAWINGS

FIG. 1 is a block diagram of an ultrasonic cleaning system in accordance with various examples.

FIG. 2 is a block diagram of an ultrasonic cleaning system in accordance with various examples.

FIG. 3A is a timing diagram for an ultrasonic cleaning system in accordance with various examples.

FIG. 3B is a timing diagram for an ultrasonic cleaning system in accordance with various examples.

FIG. 4 is a block diagram of a system for sub-block data processing in accordance with various examples.

FIG. 5 is a flow diagram of a method for managing a PWM signal in accordance with various examples.

FIG. 6 is a flow diagram of a method for managing a PWM signal in accordance with various examples.

The Same Reference Numbers or Other Reference Designators are Used in the Drawings to Designate the Same or Similar (Functionally and/or Structurally) Features.

### DETAILED DESCRIPTION

Some ultrasonic cleaning systems include a user interface and a data processing component. The user interface responds to commands from a host. Example commands may include initiating a cleaning sequence, reconfiguring the ultrasonic cleaning system, or aborting a process. The data processing component includes a transmitter (TX) path and a receiver (RX) path. The TX path sends an excitation signal of a particular frequency, amplitude, and duration to a transducer, and the transducer may be used to clean a surface, as described above. A TX cleaning sequence may include multiple iterations with different frequencies, amplitudes or durations. The RX path senses electrical signals related to the transducer (such as current and voltage) and determines the resonance behavior of the transducer using impedance computations. Such information obtained from the RX path is used to control the TX path.

Some ultrasonic cleaning systems use a multi-threaded processing architecture, which has separate mechanisms for RX processing, TX processing and host commands. These systems may also utilize slow block-by-block processing of RX data, where data is collected until a certain amount is collected (e.g., a block of samples), and then processing occurs only after the full block is collected. These systems may also use large amounts of memory and processing resources. These systems may be difficult to reconfigure and may have separate clock modules to manage the different processing threads. Accordingly, such ultrasonic cleaning systems are inefficient and expensive.

In examples herein, an ultrasonic cleaning system architecture uses a single processing thread to process real-time RX data, maintain accurate timing of the TX cleaning sequence, and service the host interface. Examples herein provide a flexible architecture that may be reconfigured based on the latency and/or resolution of the system. A single RX thread can handle all the system requirements, including the TX cleaning sequence, the RX data analysis, and the user interface via the host. An RX data processing block may be partitioned into multiple, smaller sub-blocks, which provides for faster and more efficient RX processing. The frequency of collection of the sub-blocks allows control signals from the host to be serviced at the frequency that sub-blocks are collected, which produces a fast response to these control signals. The sub-block frequency is also used to synchronize the TX cleaning sequence with the RX processing. Data processing actions work across the sub-block boundaries, using windowing of input samples and discrete Fourier transform (DFT) computations. The TX sequence duration is configured as a multiple of the RX sub-block frequency, which allows the RX sub-block timing to also be used for the TX sequences. This single-threaded architecture is reconfigurable, and may be changed based on the latency and resolution of the system, as well as system resource requirements. Examples described herein provide savings in terms of memory, power, and chip area. Separate system clock modules are not needed for different processing threads.

Examples herein may be used in a variety of applications, such as automotive or industrial application. As one example, systems and methods described herein may clean camera lenses, sensors, or other devices. For example, camera lenses used in automobiles for self-driving or safety applications may benefit from ultrasonic cleaning to keep the lenses free from debris. Camera lenses or other sensors used in industrial applications to monitor processes or systems may also benefit from ultrasonic cleaning to keep water, dust, or other debris off of the lens or sensor.

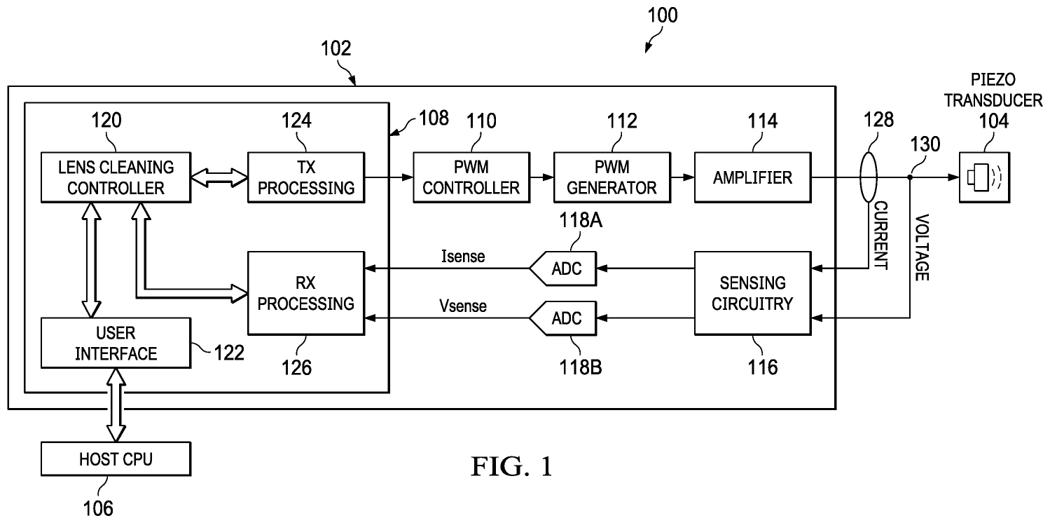

FIG. 1 is a system 100 for ultrasonic cleaning in accordance with various examples herein. System 100 includes lens cleaning system 102, piezo transducer 104, and host central processing unit (CPU) 106. Lens cleaning system 102 includes a digital signal processor (DSP) 108, pulse-width modulation (PWM) controller 110, PWM generator 112, amplifier 114, sensing circuitry 116, and analog to digital converters (ADC) 118A and 118B. DSP 108 includes a lens cleaning controller 120, user interface 122, TX processing 124, and RX processing 126. System 100 also includes current sense 128 and voltage sense 130. In some examples, DSP 108 may be implemented using a digital signal processor, microcontroller, logic circuitry, analog circuitry, state machine, other type of processor, memory, buffers and/or any combination thereof.

In a brief description of the operation of system 100, TX processing 124 manages generation of an excitation signal with a specific frequency, amplitude, and duration. TX processing 124 may provide instructions to PWM controller 110, PWM generator 112, and amplifier 114 (which may be a class D amplifier), to provide the excitation signal to piezo transducer 104. TX processing 124 may be any appropriate circuitry, or may include a processor or controller and software. Piezo transducer 104 vibrates to clean a surface coupled to (e.g., adhered to, affixed to or in contact with) piezo transducer 104. Current is sensed by current sense 128 and voltage is sensed by voltage sense 130 between the amplifier 114 and the piezo transducer 104. The current and voltage measurements are provided by sensing circuitry 116 to RX processing 126, which processes digital data from the ADCs 118A and 118B and provides impedance measurements to the lens cleaning controller 120 in this example. RX processing 126 may be any appropriate circuitry, or may include a processor or controller and software. Impedance may be calculated by lens cleaning controller 120, for example. Lens cleaning controller 120 may communicate with TX processing 124 to alter the excitation signal based at least in part on the voltage and current feedback from RX processing 126. A user interface 122 allows a host CPU 106 to interact with lens cleaning system 102.

The frequency, amplitude, and duration of the excitation signal are controlled as user input parameters, and may be programmed to be in a correct frequency range to vibrate the piezo transducer 104 to effectively clean water and/or debris off of a surface. Frequency, amplitude, and/or duration of the excitation signal may be adjusted to determine the parameters that most effectively clean the surface. An example method includes sweeping frequency across a range of frequencies. Current and voltage at the piezo transducer 104 are measured with current sense 128 and voltage sense 130 to determine the frequency region in which minimum or near-minimum impedance across the piezo transducer 104 occurs. The frequency region in which minimum or near-minimum impedance occurs may be used to drive the excitation signal from TX processing 124. The feedback system described herein includes a TX path that excites the system and an RX path that receives the current from current sense 128 and voltage from voltage sense 130 and then determines the resonance behavior using impedance. The feedback system described herein therefore determines an effective cleaning sequence and also protects the system from faults and/or damage. Also, a user may use user interface 122 to trigger the cleaning operation, reconfigure the system, or abort a sequence.

Lens cleaning controller 120 provides configuration and calibration of system 100. Lens cleaning controller 120 includes software to provide one or more functions such as material detection on the surface to be cleaned, temperature estimation and regulation, system monitoring and diagnostics, and fault handling. TX processing 124 provides the generation of the excitation signal provided to piezo transducer 104. RX processing 126 provides feedback regarding impedance of the piezo transducer 104. User interface 122 receives commands from host CPU 106, produces alerts and notifications for host CPU 106. In examples herein, a single thread controls the RX processing 126, the TX processing 124, and the user interface 122. The single thread provides scalability and reconfigurability for system 100, as described below. The single thread also reduces resource usage in system 100.

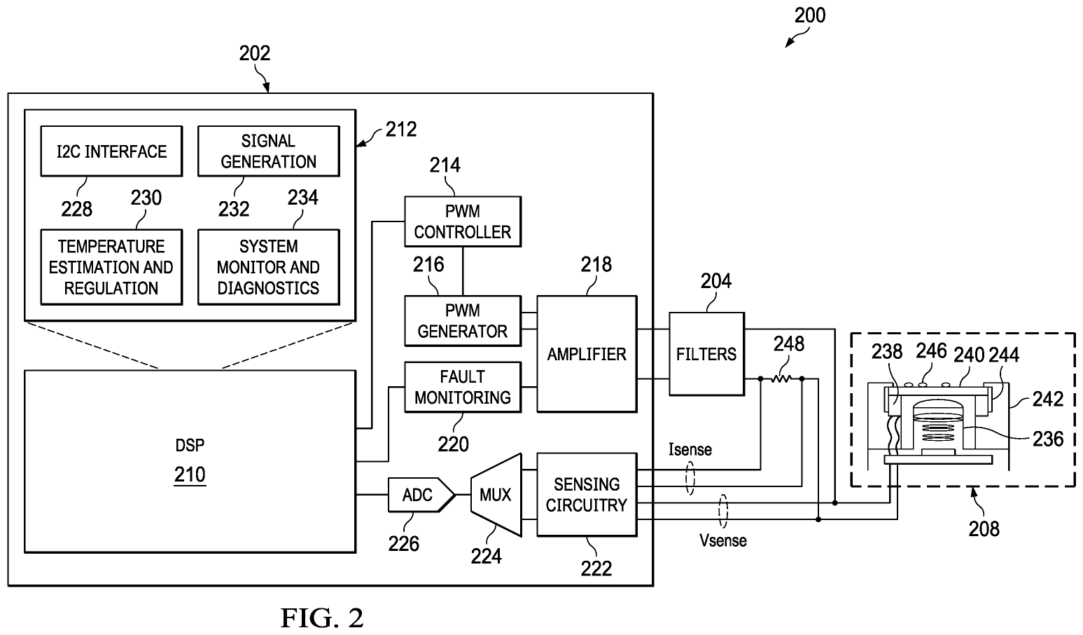

FIG. 2 is an ultrasonic cleaning system 200 in accordance with various examples herein. System 200 includes many of the components described above with respect to FIG. 1, such as a PWM controller, PWM generator, sensing circuitry, piezo transducer, etc. These components in FIG. 2 may be functionally and/or structurally equivalent or similar to the components in FIG. 1. System 200 includes an ultrasonic cleaning chip 202, filters 204, and lens cleaning system 208. Ultrasonic cleaning chip 202 includes DSP 210, which hosts control processes 212, PWM controller 214, PWM generator 216, amplifier 218, fault monitoring 220, sensing circuitry 222, multiplexer 224, and ADC 226. Control processes 212 include I2C interface 228, temperature estimation and regulation 230, signal generation 232, and system monitor and diagnostics 234. Lens cleaning system 208 includes camera lens (or sensor) 236, piezo transducer 238, lens cover 240, housing 242, and gasket 244. Water droplets 246 are also shown on lens cover 240. System 200 also includes a current sense resistor 248 for sensing the current provided to piezo transducer 238 and providing this value to sensing circuitry 222. Voltage is sensed across the piezo transducer 238 and this value is provided to the sensing circuitry 222.

In this example, system 200 cleans the lens cover 240 over the camera lens 236. System 200 could be used to clean other devices in other examples. Here, lens cover 240 covers camera lens 236 to protect camera lens 236 from water or other debris. Camera lens 236 may be a lens for a camera on a vehicle or on a camera used in an industrial application. During operation, water, dust, or other debris may collect on lens cover 240. Water droplets 246 represent the debris on lens cover 240 in this example. Water droplets 246 should be removed from lens cover 240 so camera lens 236 has a clear view for operation. System 200 provides ultrasonic cleaning for lens cover 240 to help keep lens cover 240 free of debris. In other examples, lens cover 240 is not utilized in the system and piezo transducer 238 cleans lens 236, directly, or lens 236 is not utilized in the system and lens cover 240 is the lens for the camera.

DSP 210 provides instructions to PWM controller 214 to produce a PWM signal for the ultrasonic cleaning application. The instructions may include a frequency, amplitude, and duration of the PWM signal. PWM generator 216 generates the PWM signal and provides the PWM signal to amplifier 218 for amplification. The amplified PWM signal is filtered by filters 204 and provided to piezo transducer 238. Piezo transducer 238 vibrates based on the frequency, amplitude, and duration of the PWM signal. Piezo transducer 238 is coupled to lens cover 240, so lens cover 240 also vibrates. The vibration helps to clear water droplets 246 and other debris from lens cover 240.

System 200 also includes an RX path or sensing path. The sensing path includes sensing circuitry 222, which senses the current and voltage at the piezo transducer 238. The sensing circuitry 222 provides the current and voltage measurements to multiplexer 224, which may be controlled by DSP 210 or another controller. Multiplexer 224 multiplexes the current and voltage measurements in one example. The ADC 226 converts the analog output of multiplexer 224 to a digital signal, which is subsequently provided to DSP 210. DSP 210 uses processes (such as control processes 212) to determine the impedance of the lens cleaning system 208. In one example, a number of different frequencies of the PWM signal are tested, and the impedance at each frequency is determined. The frequency region that produces the minimum or near-minimum impedance may be selected for a cleaning sequence. The frequencies and/or amplitudes of the PWM signal may be periodically changed and tested to continually update system 200 so that a favorable frequency is used for the PWM signal. In some examples, the frequency region that provides the minimum or near-minimum impedance is used to clean lens cover 240.

DSP 210 may control system 200 using control processes 212 and/or other processes not shown in FIG. 2. Control processes 212 may be embodied in executable code in some examples. Control processes 212 may be a combination of code and data structures in some examples. Control processes 212 includes I2C interface 228, which is an interface for a serial communication protocol. Temperature estimation and regulation 230 provides control for various temperature conditions. Signal generation 232 includes processes for generating TX excitation signals with programmed frequencies, amplitudes, and durations. System monitor and diagnostics 234 includes control processes for monitoring and diagnosing various system activities.

As described above, examples herein use a single processing thread to control the transmit functions, the receive functions, and the host interface functions. The single processing thread makes the system scalable and reconfigurable, while also providing savings of memory, power, and chip area.

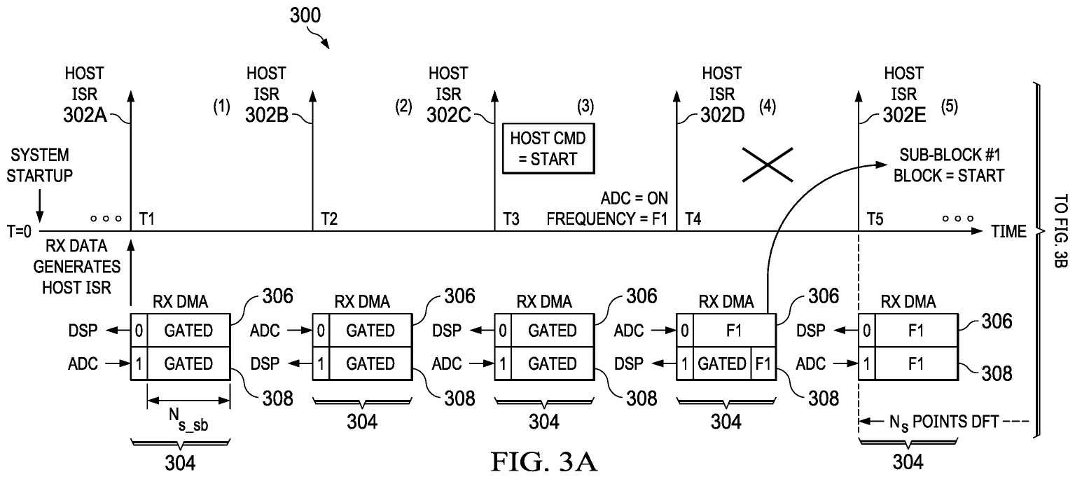

FIG. 3A is a timing diagram 300 for an ultrasonic cleaning system in accordance with various examples herein. FIG. 3A shows five time intervals for timing diagram 300. Time intervals beyond the first five time internals are shown in FIG. 3B, which is a continuation of FIG. 3A. In examples herein, a host interrupt service routine (ISR) generates interrupts at intervals that correspond to the sub-block frequency of the RX data. The interrupts used in examples herein to provide timing for the actions performed are referred to as ISRs. Also, the sub-block frequency is the frequency that RX data is collected for processing. The blocks, sub-blocks, and their relation to the sampling frequency are described below. Therefore, the same timing mechanisms corresponding to the host ISRs are used to perform RX processing, synchronize TX sequencing, and service requests or commands from the host interface. As described below, RX data processing is partitioned across multiple sub-blocks. The number of sub-blocks may be reconfigured to manage systems with different latencies, resolutions, and available system resources. For example, some systems may more efficiently process sub-blocks that have fewer samples, so the sub-blocks may contain fewer samples in those systems. In other systems, the sub-blocks may contain more samples in each sub-block. The use of a single thread to manage RX, TX, and host services provides flexibility and scalability of the examples described herein.

In examples herein and as described above, the TX path includes a PWM generator (such as PWM generator 112 or 216) that excites the piezo transducer (104, 238) with a given excitation frequency and amplitude. The current and voltage across the piezo transducer (104, 238) are processed and/or recorded using sensing circuitry (116, 222), which may include ADCs (118A, 118B, 226) that digitize the current and voltage samples. Fₛ refers to the sampling frequency of the RX path. Fₛ is the frequency at which samples of the current and voltage of the piezo transducer (104, 238) are taken. Nₛ is the total number of samples in one RX block. Nₛ could be 1024, 2048, 4096, etc., in some examples. N_{sb} is the number of sub-blocks in one RX block. Fₛ and N_{sb} determine the ISR rate of the system. Processing of RX samples may be performed at a sub-block level in examples herein. As one example, N_{sb} may be 4, so there are 4 sub-blocks in each RX block. N_{s_sb} is the number of samples in one RX sub-block. Therefore, N_{s_sb}=Nₛ/N_{sb}. If Nₛ is 2048 and N_{sb} is 4, N_{s_sb}=2048/4, or 512. As another example, the interrupt frequency is Fₛ/N_{s_sb}. If Fₛ is 500 kHz, and N_{s_sb} is 512, the interrupt frequency is 500 kHz divided by 512, which is approximately 1 millisecond. Therefore, the ISRs occur approximately every 1 millisecond in one example.

In one example, the system starts up at time T=0. At each ISR 302 (shown as 302A, 302B, 302C, 302D, and 302E in FIG. 3A), TX data is generated and sampled. The RX samples are digitized in the RX path and stored using a direct memory access (DMA) controller in ping-pong mode. Ping-pong mode stores data using two buffers (a ping buffer and a pong buffer), where data is stored in a first buffer while the data in the second buffer is processed. Then, at the appropriate time, data is stored in the second buffer while the data in the first buffer is processed. The two buffers alternate between data storage and data processing. In this example, buffers 304 include a ping buffer 306 (labeled 0 in FIG. 3A) and a pong buffer 308 (labeled 1 in FIG. 3A). After a sub-block of equivalent data (e.g., N_{s_sb} samples) is transferred to the ping-pong buffers (306 or 308), the DMA generates an ISR. The ISR is used for TX excitation signal sequencing, sub-block RX data processing, and host command service. Therefore, a single thread manages the TX signal, the RX processing, and the host services.

In the example in FIG. 3A, a host ISR is generated at time T1. At this time, the RX path and ADCs are activated. Samples are discarded at this time so the TX path can be configured and the mechanical system may settle and begin operating. Therefore, buffers 306 and 308 are shown as gated. No data is being stored to buffers 306 and 308 at time interval 1 between T1 and T2, or at time interval 2 between T2 and T3. The ISR slot between T1 and T2 is numbered as time interval (1) and the ISR slot between T2 and T3 is numbered as time interval (2), and so on. At the third ISR (302C) at time T3, the TX path turns on. The PWM generator (112, 216) generates a TX signal with frequency F1, with an amplitude A1, and a duration D1 and excites the piezo transducer. The duration D1 is a multiple of the sub-block data processing period. The running duration D1 continues for a set time, and after the duration D1 is complete, the frequency may be changed to a different frequency F2. The amplitude may also be changed to a new amplitude A2. In some examples, the amplitude may stay the same. The duration D1 changes to D2. In some examples, D2 is the same as D1. Therefore, the TX path transmits a signal at F1 for a specified time (D1), and then switches frequencies to transmit the signal at F2 for a specified time (D2). This process continues until a range of frequencies has been used, such as 10, 12, or 20 different frequencies, etc. While the signals with different frequencies are being transmitted, the RX path samples the current and voltage at the piezo transducer (104, 238) and processes the current and voltage data. After the TX signal has been transmitted at each of the different frequencies, processing (such as processing by lens cleaning controller 120) can determine the impedance of the transducer at each of the different transmit frequencies. The transmit frequency region with the minimum or near-minimum impedance may be selected as the frequency region for the ultrasonic cleaning system, and then the cleaning system may operate a cleaning sequence using that selected frequency region. The cleaning sequence with the selected frequency region may be operative for a set amount of time to clean the lens cover 240. The cleaning sequence may then be completed and used again at a later time. Alternatively, another testing sequence may be performed with a range of transmit frequencies to select the transmit frequency region with the minimum or near-minimum impedance and then another cleaning sequence may be performed.

In FIG. 3A, the ADC 226 starts up at time T3, and the excitation signal is transmitted on the TX path during the third time interval between T3 and T4. At time T4, buffers 304 include a mix of valid ADC current and voltage data and invalid gated data. Therefore, the data in the buffers 304 is ignored at time interval (4), which is marked with an X in FIG. 3A. Also, due to the TX path turning on at time interval T1, the voltage across the piezo transducer (104, 238) may take time to settle, and therefore it is possible that more ISR slots (over and above time interval 4) may be ignored.

During time interval (5), after ISR 302E at time T5, data processing may begin using the RX path. This ISR slot is numbered 5 and is the first sub-block for the given block (first block) whose processing has started at time T5. Time interval (4) shows that data in buffers 304 is current and voltage data created by an excitation signal with a frequency of F1. A first buffer (306 or 308) stores data, while the data in the second buffer (306 or 308) is processed. At the next time interval, the buffers (306 and 308) switch, and the sampled data is stored in the second buffer (306 or 308), while the data stored in the first buffer (306 or 308) is processed. The RX data storage and processing ping-pongs like this in response to each ISR.

FIG. 3A shows that the size of each buffer 306 and 308 is Nₛ sb entries. In one example, this may be 512 entries. At time interval (5), 512 samples stored in one of the buffers 304 during time interval (4) are available for processing sub-block 1. The other buffer 304 stores data samples to be used for processing in time interval (6). An Nₛ points DFT will be performed after data for all the sub-blocks has been read and stored by the RX processing path. Nₛ is 2048 samples in this example, with 4 sub-blocks that each have 512 samples. After time interval (5), the process continues at time interval (6) shown in FIG. 3B.

FIG. 3B is a timing diagram 350 for an ultrasonic cleaning system in accordance with various examples herein. FIG. 3B is a continuation of the timing diagram 300 shown in FIG. 3A. At time T6, ISR 302F is generated. During time interval (6), 512 samples are stored in one of the buffers 304, while 512 samples are processed in the other buffer 304. The ISR slot corresponding to these 512 samples is numbered as 6 and it is the second sub-block for the first block whose processing has started at time T5. At time T7, ISR 302G is generated. In some examples, one or more sub-blocks of samples may be sampled and processed between time T6 and T7 i.e., ISR 302F and ISR 302G may not be consecutive ISR events. At time T7, another sub-block of samples is sampled and processed. At time T8, ISR 302H is generated, and another sub-block of samples are sampled and processed. In this example, the time interval between times T8 and T9 is ISR slot (4+N_{sb}) and it is the final sub-block N_{sb} for the first block whose processing has started at time T5. N_{sb} is the number of sub-blocks in one RX block. N_{sb} could be four in one example, but could also be as low as 1 or as high as Nₛ. The number of samples per sub-block is inversely proportional to the number of sub-blocks. The variable number of sub-blocks provides scalability for the ultrasonic cleaning system.

In this example, data processing for the first block was initiated at ISR slot 5 in FIG. 3A, and continues until ISR slot (4+N_{sb}), in the center of FIG. 3B. Slot (4+N_{sb}) is the last sub-block and this slot concludes data processing for one full block. The RX path continues to run to provide the ISR to the host CPU 106.

At ISR slot (4+N_{sb}) (time T8), the host CPU 106 initiates a switch command. The duration of the current cleaning sequence with F1 is concluded and the next sequence should be initiated. Therefore, the PWM is reconfigured to begin transmitting at frequency F2, amplitude A2, and duration D2. The data received at the buffers 304 after the next ISR 302I may be ignored because it is a mix of F1 and F2 data. This situation is shown in FIG. 3B with an X in ISR slot (5+N_{sb}). Also, due to the change in frequency, the voltage across the piezo transducer (104, 238) may take time to settle, and therefore it is possible that more ISR slots (over and above ISR slot (5+N_{sb})) may be ignored. In addition, the number of ISR slots ignored when the TX path turns on and the number of ISR slots ignored when the TX path changes frequency may be different from one another.

The sub-block data processing for frequency F2, amplitude A2, and duration D2 is initiated in ISR Slot (6+N_{sb}) (after ISR 302J) and continues until ISR Slot (5+2*N_{sb}) (not shown in FIG. 3B). Slot (5+2*N_{sb}) is the last sub-block for the second block, and it concludes data processing for the second full block.

This type of block processing continues with different frequencies until all programmed frequencies have been transmitted. At the completion of each full RX block, the following actions may be taken. First a result may be reported to the host CPU 106 using a host ISR. Second, the TX excitation signal may be modified. The frequency and/or amplitude of an initiated cleaning sequence may be altered based on the results of the analysis of the RX block. For example, if a frequency region is found with a lower impedance than the current frequency region used for cleaning, the frequency region of the cleaning sequence may be updated. Third, a new TX sequence may be started if the duration of the current cleaning sequence is concluded and there is an entry for the next cleaning sequence. Fourth, the system may handle a new command or a new TX sequence from the host.

The RX path processes current and voltage data samples by performing Fourier analysis of the signals. The impedance, temperature, and control may be measured based on the DFT. The data samples are processed on a sub-block by sub-block basis. Windowing may be used in some examples, which processes a subset of the samples rather than all of the samples. The approach of processing in sub-blocks reduces buffering requirements for the system. Sub-blocks of data may be stored and processed rather than entire blocks of data, which reduces storage requirements.

The architecture described herein is programmable in terms of Fₛ, Nₛ, and N_{sb}. For a given Nₛ (e.g., a specific number of DFT points), the N_{sb} may be modified to make the control ISR faster or slower depending on resource availability or host response rate. Because the sub-block scheme described herein is able to store the processing states across sub-blocks, the DFT computation is accurate irrespective of the value of N_{sb}.

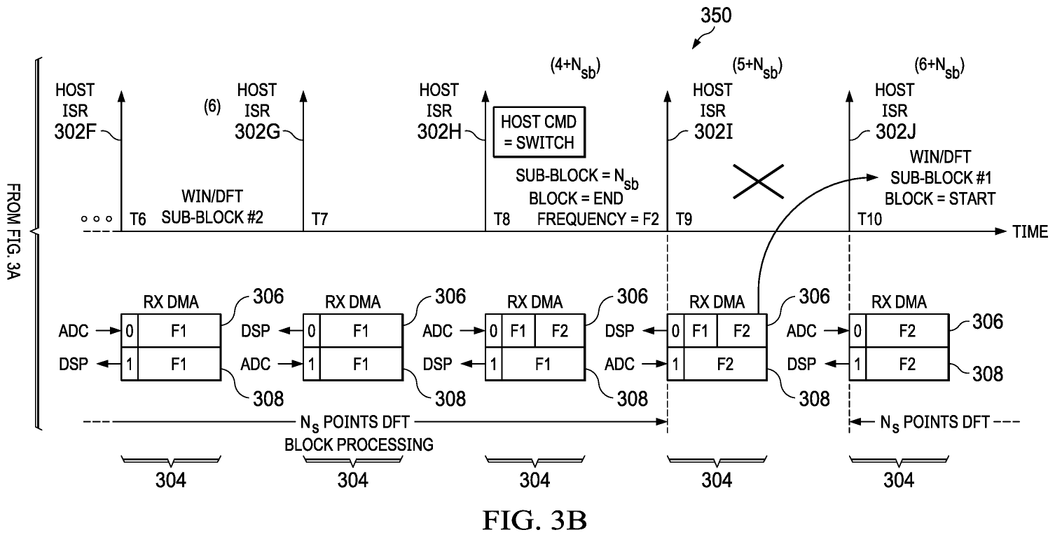

FIG. 4 is a system 400 for sub-block data processing in accordance with various examples herein. The components shown in system 400 may be embodied in hardware (e.g., a processor, microcontroller, digital circuitry, analog circuitry, memory, buffers, logic circuitry and/or a state machine), software, or a combination thereof. FIG. 4 shows how the RX path processes sub-block data in one example.

System 400 includes piezo transducer 402, IV (current/voltage) sense 404, RX DMA 406, RX ping buffer 408A, RX pong buffer 408B, hardware abstraction layer (HAL) 410, RX buffer 412, unpack processing 414, temporary buffer 416, and FOR loop processing 418. FOR loop processing 418 includes windowing processing 420 and DFT processing 422. System 400 also includes window table 424, DFT results 426, PWM drive 428, and amplifier 430. In one example, IV sense 404, RX DMA 406, PWM drive 428, and amplifier 430 may be implemented in hardware. RX ping buffer 408A, RX pong buffer 408B, RX buffer 412, temporary buffer 416, and window table 424 may be located in DSP memory or in any other memory. HAL 410 may be implemented in software to interface between the hardware and software. Unpack processing 414, FOR loop processing 418, windowing processing 420, DFT processing 422, and DFT results 426 may be components of a DSP system in some examples.

In operation, a PWM excitation signal is provided to piezo transducer 402 via PWM drive 428 and amplifier 430. Current and voltage at the piezo transducer 402 is sensed with IV sense 404. IV sense 404 may use any type of circuitry to capture and/or sense the current and voltage samples, as described above with FIGS. 1 and 2. The I (current) and V (voltage) samples are provided to RX DMA 406 and stored in RX ping buffer 408A and RX pong buffer 408B, as described above. Each buffer (406A and 406B) may store N_{s_sb} samples in one example. In this example, the number of samples Nₛ is 2048, the number of sub-blocks N_{sb} is 4, and the number of samples per sub-block N_{s_sb} is 512. Other values for these variables may be used in other examples.

The I and V samples are provided to HAL 410 and then to RX buffer 412. RX buffer 412 is a 32-bit buffer. Half of RX buffer 412 includes current samples, and half includes voltage samples. N_{s_sb} (512) current samples and Nₛ sb (512) voltage samples are stored in RX buffer 412. The data in RX buffer 412 is unpacked by unpack processing 414 into temporary buffer 416, where the current samples and the voltage samples are separately processed with the host processes. As an example, the current samples are unpacked first from RX buffer 412 and stored in temporary buffer 416. Then, a partial DFT is performed and the results are stored. After that, processing of the current samples is complete. Then, the voltage samples are unpacked by unpack processing 414 and stored in temporary buffer 416. A partial DFT is performed on the voltage samples and the results are stored. After the partial DFT is performed for both the current and voltage samples, processing for that particular sub-block is concluded. Also, windowing is performed before each DFT using window table 424. Windowing is the process of taking a small subset of a larger dataset for processing and analysis. For example, a 2048 window table 424 may be used to generate window samples for 2048, 1024, or 512 DFT points. Windowing processing 420 performs windowing on the samples from temporary buffer 416 using windowing table 424. Windowing processing 420 retrieves the samples from temporary buffer 416 and performs windowing. The output of windowing processing 420 is then stored back into temporary buffer 416. DFT processing 422 performs a DFT on the windowed output, after windowing is performed.

DFT processing 422 is performed for each sub-block of samples. States are used to store and restore the processing context across sub-blocks. Therefore, the entire block of samples may be processed sub-block by sub-block, instead of storing the entire block of samples and processing the entire block in one DFT operation. Processing the samples sub-block by sub-block provides scalability, reconfigurability, and savings in memory, power, and chip area. The sub-blocks may be any size, as described above. The DFT computation is accurate regardless of the sub-block size, because DFT processing 422 manages the computations across sub-blocks until all (or substantially all) sub-blocks are processed.

After DFT processing 422 is performed on the current samples and the voltage samples for the total number of sub-blocks that make up the block, DFT results 426 may provide information regarding the impedance, temperature, and control of the PWM drive 428. As an example, the frequency region that corresponds to the lowest impedance may be determined via DFT processing 422. Then, the amplitude and the frequency associated with the lowest impedance may be provided to PWM drive 428, so PWM drive 428 may adjust the excitation signal to provide improved cleaning by the piezo transducer 402. As described above, additional current and voltage samples may then be taken to continually provide feedback and improve the results of the ultrasonic cleaning system.

In other examples, the DFT may be performed before a full sub-block of samples are collected and stored in RX buffer 412. The DFT may also be performed on sub-blocks instead of a full block of samples. In other examples, separate window tables 424 may be used instead of the single window table 424 described in FIG. 4.

After the DFT is complete, the RX thread may make any of a number of decisions. As described above, the TX path may be changed, such as changing the frequency of the excitation signal. In another example, results may be reported to the host. A new TX sequence may be started in some examples.

The examples herein concern the DSP portion of an ultrasonic lens cleaning system. The lens cleaning controller 120 interacts with three primary tasks/threads—TX processing 124, RX processing 126, and the user interface 122. Unlike systems using multi-threaded complex real-time design, the architecture described herein uses a single scalable thread which is synchronized to the RX processing interrupt. At every RX interrupt (e.g., ISR) the lens cleaning controller 120 may interact with the host CPU 106 via the user interface 122 to exchange commands, notifications, etc. The lens cleaning controller 120 may also interact with TX processing 124 to control the excitation signal that is sent to the piezo transducer 104, for example by reconfiguring the signal or stopping the signal or starting the signal, etc. The lens cleaning controller 120 may interact with RX processing 126 to analyze the behavior of piezo transducer 104. For example, RX processing 126 may produce impedance data to determine the resonance point of the piezo transducer 104, check if piezo transducer 104 is getting overheated, etc. While the lens cleaning controller 120 primarily configures the TX processing 124 and RX processing 126, the processing portions may operate on their own as well. For example, after configuration, TX processing 124 may continue to provide the duty cycle information to PWM controller 110 to generate the excitation signal. Similarly, after configuration, RX processing 126 may continue to run the DFT algorithm across sub-blocks and blocks to measure impedance, etc.

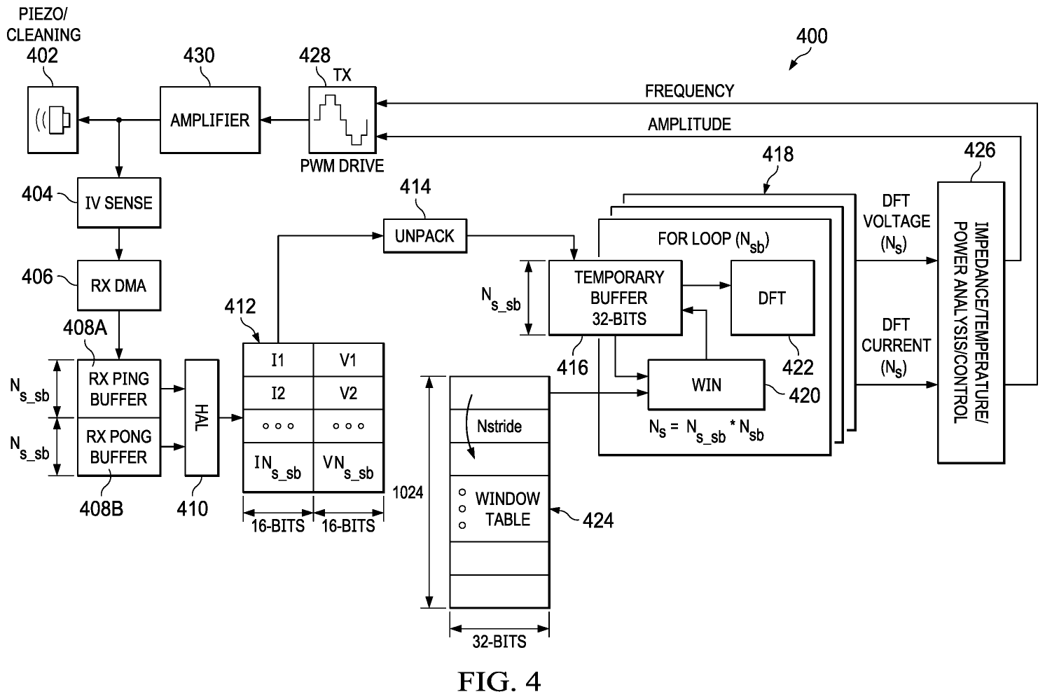

FIG. 5 is a flow diagram of a method 500 for managing a PWM signal for a piezo transducer in accordance with various examples herein. The steps of method 500 may be performed in any suitable order. The hardware and/or software components described above with respect to FIGS. 1, 2, and/or 4 may perform method 500 in some examples.

Method 500 begins at 510, where a transmit path provides a PWM excitation signal to a piezo transducer. As one example, TX processing 124, PWM controller 110, PWM generator 112, and amplifier 114 in FIG. 1 provide the PWM excitation signal to piezo transducer 104.

Method 500 continues at 520, where sensing circuitry collects a block of samples of a current and a voltage at the piezo transducer, where the block of samples is collected in sub-blocks of samples between interrupts in a receive path. Sensing circuitry 116 in FIG. 1 is one example of sensing circuitry that collects current samples and voltage samples. The samples may then be digitized with ADC 118A and ADC 118B and provided to RX processing 126. FIGS. 3A and 3B show how the samples are collected in sub-blocks between each ISR.

Method 500 continues at 530, where RX processing processes each sub-block of samples separately from other sub-blocks of samples. As described above with respect to FIG. 4, sub-blocks are processed separately with FOR loop processing 418. The results of processing each sub-block are stored and used for subsequent sub-block processing, which provides an accurate result after all of the sub-blocks of a block have been processed.

Method 500 continues at 540, where a DSP (e.g., DSP 108) performs an analysis of the block of samples responsive to all sub-blocks of samples being processed. The analysis may be a DFT in some examples. The analysis may be a frequency analysis that provides a frequency region corresponding to minimum or near-minimum impedance of the system. The analysis may also be useful for impedance or temperature based control.

Method 500 continues at 550, where the DSP modifies the PWM excitation signal responsive to the analysis. The PWM excitation signal may be modified by adjusting the frequency or amplitude of the PWM signal.

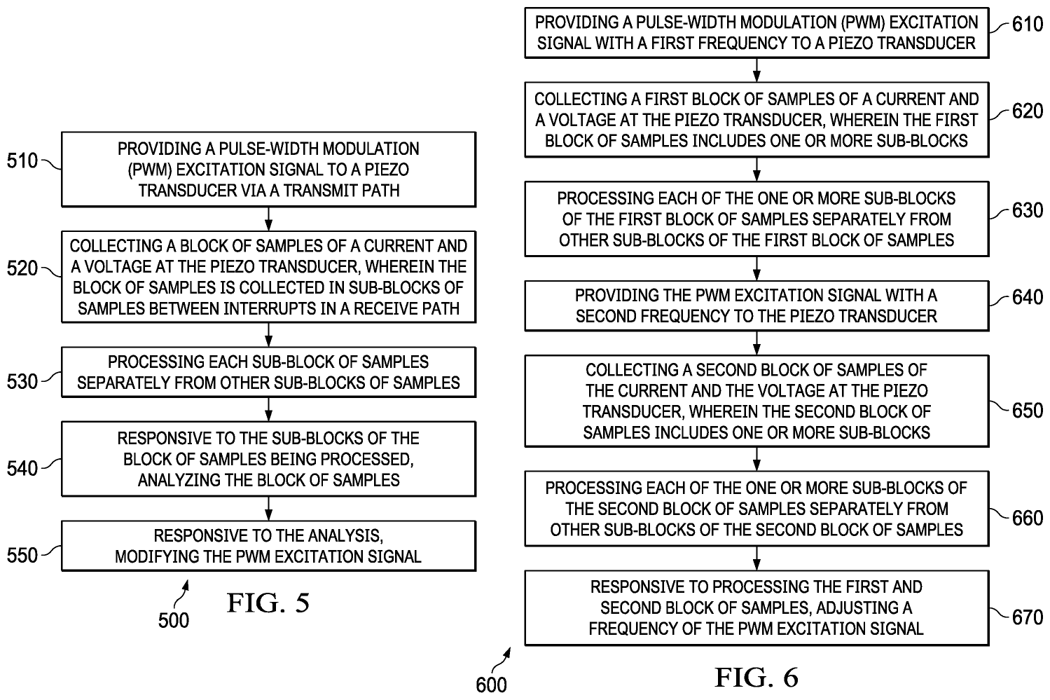

FIG. 6 is a flow diagram of a method 600 for managing a PWM signal for a piezo transducer in accordance with various examples herein. The steps of method 600 may be performed in any suitable order, or simultaneously in some examples. For example, some samples may be collected while other samples are being processed. The hardware components described above with respect to FIGS. 1, 2, and/or 4 may perform method 600 in some examples.

Method 600 begins at 610, where a transmit path provides a PWM excitation signal with a first frequency to a piezo transducer. As one example, TX processing 124, PWM controller 110, PWM generator 112, and amplifier 114 in FIG. 1 provide the PWM excitation signal to piezo transducer 104.

Method 600 continues at 620, where sensing circuitry collects a first block of samples of a current and a voltage at the piezo transducer, where the first block of samples includes one or more sub-blocks. Sensing circuitry 116 in FIG. 1 is one example of sensing circuitry that collects current samples and voltage samples. The samples may then be digitized with ADC 118A and ADC 118B and provided to lens cleaning controller 120 for processing. FIGS. 3A and 3B show how the samples are collected in sub-blocks between each ISR. As described above, some sub-blocks of samples may be ignored due to settling time of the piezo transducer (104, 238).

Method 600 continues at 630, where each of the one or more sub-blocks of the first block of samples is processed separately from other sub-blocks of the first block of samples. Processing of the sub-blocks is described above with respect to FIG. 4. DFT processing may be performed in one example. Processing the samples sub-block by sub-block provides scalability, reconfigurability, and savings in memory, power, and chip area. The sub-blocks may be any size, as described above.

Method 600 continues at 640, where a transmit path provides a PWM excitation signal with a second frequency to a piezo transducer. As one example, TX processing 124, PWM controller 110, PWM generator 112, and amplifier 114 in FIG. 1 provide the PWM excitation signal to piezo transducer 104. The PWM controller 110 or TX processing 124 may provide the second frequency in one example.

Method 600 continues at 650, where sensing circuitry collects a second block of samples of the current and the voltage at the piezo transducer, where the second block of samples includes one or more sub-blocks. The samples may be collected as described with respect to 620 above. As described above with respect to FIG. 3B, some sub-blocks of samples may be ignored due to settling time of the piezo transducer (104, 238) caused by the change in frequency.

Method 600 continues at 660, where each of the one or more sub-blocks of the second block of samples is processed separately from other sub-blocks of the second block of samples. The sub-blocks may be processed as described with respect to 630 above.

Method 600 continues at 670, where the TX path or DSP (e.g., DSP 108) adjusts a frequency of the PWM excitation signal responsive to processing the first and second block of samples. In one example, the frequency may be adjusted to a frequency region that provides a minimum or near-minimum impedance for the piezo transducer (104, 238). In another example, an amplitude of the PWM excitation signal may be adjusted (in place of or in conjunction with adjusting the frequency) responsive to the processing, where the amplitude is adjusted to an amplitude that provides a minimum or near-minimum impedance for the piezo transducer (104, 238).

In examples described herein a system architecture uses a single thread to initiate processes and process the real-time RX data, maintain accurate time resolution of the TX cleaning sequence, and service the host interface. The single RX thread can initiate and handle all the system requirements: the TX cleaning sequence, the RX data analysis, and the user interface via the host. An RX data processing block may be partitioned into multiple smaller sub-blocks, which provides for faster and more efficient RX processing. The frequency of the sub-blocks allows control signals from the host to be serviced at the sub-block frequency, which produces a fast response to these control signals. The sub-block frequency also synchronizes the TX cleaning sequence. Data processing operations work across the sub-block boundaries, using windowing of input samples and DFT computations. The TX sequence duration is configured as a multiple of the RX sub-block period. The single-threaded architecture is reconfigurable, and may be changed based on the latency and resolution of the system, as well as system resource requirements. Examples described herein provide savings in terms of memory, power, and chip area.

The term “couple” is used throughout the specification. The term may cover connections, communications, or signal paths that enable a functional relationship consistent with this description. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

While certain elements/features may be included in an integrated circuit and other elements/features are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Unless otherwise stated, “about,” “approximately,” or “substantially” preceding a value means+/−10 percent of the stated value. Modifications are possible in the described examples, and other examples are possible within the scope of the claims.

What is claimed is:

1. A method, comprising:
providing a pulse-width modulation (PWM) excitation signal to a piezo transducer via a transmit path;
collecting a block of samples of a current and a voltage at the piezo transducer, wherein the block of samples is collected in sub-blocks of samples between interrupts in a receive path;
processing each sub-block of samples separately from other sub-blocks of samples;
responsive to the sub-blocks of the block of samples being processed, analyzing the block of samples; and
responsive to the analysis, modifying the PWM excitation signal.

2. The method of claim 1, further comprising:
responsive to the analysis, reporting a result to a host computer.

3. The method of claim 1, further comprising:
responsive to the analysis, beginning a transmit sequence on the transmit path to generate a PWM signal that includes multiple frequencies for the PWM excitation signal.

4. The method of claim 1, wherein modifying the PWM excitation signal includes altering a frequency of the PWM excitation signal.

5. The method of claim 1, wherein the analysis of the block of samples includes performing a discrete Fourier transform (DFT) on the block of samples.

6. The method of claim 1, wherein analyzing the block of samples includes determining an impedance associated with the piezo transducer.

7. The method of claim 1, wherein processing each sub-block of samples includes:
performing a DFT on the samples of the current; and
performing a DFT on the samples of the voltage.

8. The method of claim 1, wherein the piezo transducer is configured to perform ultrasonic cleaning of a surface.

9. The method of claim 1, wherein the block of samples includes samples of different frequencies of the excitation signal.

10. The method of claim 1, wherein the transmit path and the receive path are controllable by a single processing thread.

11. A system for operating a piezo transducer, the system comprising:
a pulse-width modulation (PWM) signal generator adapted to be coupled to the piezo transducer and configured to generate a PWM signal;
sensing circuitry adapted to be coupled to the piezo transducer and configured to sample current and sample voltage of the piezo transducer; and
a processor coupled to the PWM signal generator and the sensing circuitry, the processor configured to:
provide transmit processing operations for the PWM signal;
provide receive processing operations on the sample current and the sample voltage; and
initiate the transmit processing operations and the receive processing operations with a single processing thread.

12. The system of claim 11, wherein the receive processing operations include performing a Fourier analysis of the sample current and the sample voltage.

13. The system of claim 12, wherein the receive processing operations include adjusting the PWM signal based at least in part on the Fourier analysis.

14. The system of claim 12, wherein the receive processing operations include performing the Fourier analysis on sub-blocks of the sample current and sub-blocks of the sample voltage.

15. The system of claim 11, wherein the transmit processing operations include generating multiple PWM signals for the piezo transducer, wherein each PWM signal has a different frequency.

16. The system of claim 11, wherein the piezo transducer is configured to perform ultrasonic cleaning of a surface.

17. A method, comprising:
providing a pulse-width modulation (PWM) excitation signal with a first frequency to a piezo transducer;
collecting a first block of samples of a current and a voltage at the piezo transducer, wherein the first block of samples includes one or more sub-blocks;
processing each of the one or more sub-blocks of the first block of samples separately from other sub-blocks of the first block of samples;
providing the PWM excitation signal with a second frequency to the piezo transducer;
collecting a second block of samples of the current and the voltage at the piezo transducer, wherein the second block of samples includes one or more sub-blocks;
processing each of the one or more sub-blocks of the second block of samples separately from other sub-blocks of the second block of samples; and
responsive to processing the first and second block of samples, adjusting a frequency of the PWM excitation signal.

18. The method of claim 17, wherein the processing includes:
performing a discrete Fourier transform (DFT) on a first sub-block of samples of the current; and
performing a DFT on a first sub-block of samples of the voltage.

19. The method of claim 17, wherein the processing includes:
determining a frequency of the PWM excitation signal that corresponds to a minimum impedance frequency region of the piezo transducer.

20. The method of claim 17, wherein the processing includes:
determining an amplitude of the PWM excitation signal that corresponds to a minimum impedance region of the piezo transducer.
